(19) United States
(12) Patent Application Publication
(10) Pub. No.: US 2024/0427348 A1
(43) Pub. Date: Dec. 26, 2024

(54) Autonomous robot for clearing snow from roofs

(71) Applicant: Daniel JUHLIN, Alnö (SE)

(72) Inventor: Daniel JUHLIN, Alnö (SE)

(21) Appl. No.: 18/752,667

(22) Filed: Jun. 24, 2024

Related U.S. Application Data
(60) Provisional application No. 63/510,127, filed on Jun. 25, 2023.

(51) Int. Cl. G05D 1/648; E04D 13/10; G05D 1/43; G05D 1/656; G05D 105/00

(52) U.S. Cl. CPC G05D 1/6486; E04D 13/106; G05D 1/43; G05D 1/656; G05D 2105/12

(57) ABSTRACT

A robot for clearing snow has a main body; a traction arrangement enabling motion of the robot on snow lying on a roof; a snow-removal device; and at least one depth sensor. A processing and control unit controls at least one motor to direct the robot to follow a snow-clearing path; receives a depth signal from the depth sensor(s); and, as a function of the depth signal, actively controls a snow-clearing depth by actuating the snow-removal device and, as the robot follows the snow-clearing path, adjusting a vertical snow-clearing distance so as to leave a layer of snow of a pre-determined depth on the roof after clearing and to prevent contact by the snow-removal device with a surface of the roof. During snow removal, no part of the snow-removal device contacts the roof surface other than at most the traction arrangement.

### REFERENCE TO RELATED APPLICATIONS

This application claims priority of U.S. Provisional Patent Application No. 63/510,127, filed 25 Jun. 2023.

### TECHNICAL FIELD

This invention relates to motorized devices for removing snow.

### BACKGROUND OF THE INVENTION

Almost every homeowner in northern latitudes is all too familiar with clearing snow. Rather than wield a shovel, many property owners now use snow-removal robots. Similar to robotic lawnmowers, these snow-removal robots follow either a random, trained, wire-delimited, triangulated, optically guided. or otherwise determined course. As the robots move forward, snow is channeled into some form of chute by means of an auger, tiller, brush, rotors, or similar mechanism, or simply by the forward motion of the machine, and is then ejected using a mechanism such as an impeller fan, preferably far enough away from the removal area that the area is left relatively snow-free.

Although existing snow-removal robots are sometimes adequate for removing light and dry snow on the ground, they are not well suited for more demanding environments, such as roofs, which are more difficult to monitor frequently, where tending to the robot is much less convenient, and where it may be at best inconvenient and at worse dangerous to simply eject snow onto the ground surrounding the structure where the robot is operating. Existing snow-removal machines also often require oversight and routine maintenance and repair that would be difficult to carry out when the machine needs to operate as autonomously as possible on roofs, especially the roofs of large commercial buildings.

For example, it is often necessary to clear an auger chute that becomes too hard-packed, which is why many manufacturers even deliver machines with a clearing rod or tool; moreover, snow-removal machines that rely on augers typically are supplied with a sheer pin or bolt on their drive shafts to protect the shaft against the force overload that may arise when the machine gets “stuck” and the auger chute is packed full. In a working environment on a roof, one would first need to know this has occurred, and then arrange to go up to the roof to clear or repair the machine.

Reliable, uninterrupted operation is especially important when it comes to the typically flat roofs of large commercial and residential buildings—snow has weight, and, if allowed to accumulate too much, can lead to roof collapse. A jammed auger or ejection chute might, if not quickly repaired, lead to such accumulation.

### BRIEF DESCRIPTION OF THE DRAWINGS

FIG. 1 depicts an example of an autonomous snow-removal robot.

FIG. 2 depicts various sensors that may be used to help control the robot.

FIG. 3 illustrates operation of the snow-removal robot on a rooftop.

FIG. 4 illustrates relevant components of a processing and control unit.

### DETAILED DESCRIPTION

Different embodiments of the invention have several different characteristics, any of all of which may be included in the disclosed autonomous snow-removal robot. Here, the term “robot” is used simply as a kind of “shorthand” to describe a machine that is capable of autonomous operation to carry out specified tasks, where “autonomous” is taken to mean the ability to carry out the various steps of snow removal without direct human maneuvering or control during the removal process. At the highest level, the primary task is to clear snow from a roof, but, as will be seen, this may include several other secondary and supporting operations as well.

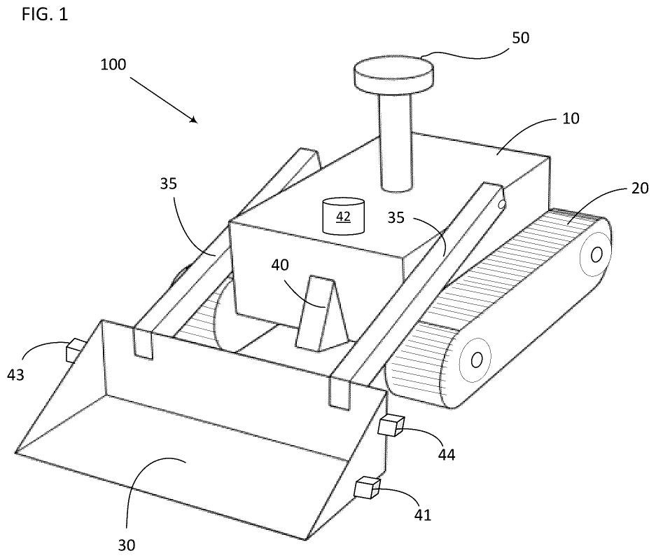

FIG. 1 illustrates the main features of the snow-removal robot 100. A main body 10 houses a processing and control unit 400 (see FIG. 4), at least one rechargeable battery or battery pack, a propulsion motor and preferably an electric or hydraulic motor to control the motions of a snow-removing device 30, which, in the illustrated embodiment, is connected to the main body via a pair of arms 35.

In the embodiment shown in FIG. 1, the robot is configured as a tracked vehicle, with tracks 20 driven in any conventional manner by the propulsion motor, which will be provided with a suitable transmission arrangement to allow the tracks to be independently driven with respect to speed and direction. Some advantages of using tracks are that they provide maximum traction, make it easy to steer the robot by adjusting the differential power to the different sides, and distribute the weight of the robot more evenly than separated wheels and so reduce the likelihood that the robot will sink into and possibly get stuck in the snow. Nonetheless, other traction arrangements, including wheels, belts, chains, etc., may also be used to provide traction and mobility on the snow. Moreover, instead of a single propulsion motor, it would be possible to provide a separate motor for the traction device (tracks, wheels, etc.) on either side, especially where propulsion power is provided via electric motors. Other single- and multiple motor arrangements may also be used, such as a hydrostatic drive, for not only propulsion power but also for actuating the snow-removing device 30, in particular, raising and lowering it and optionally changing its angle relative to the horizontal plane.

In the embodiment shown in FIG. 1, the snow-removing device 30 is a bucket. In some embodiments, the bucket is fixed relative to the arms 35. This may be done for simplicity, but may also be a chosen design in cases where the roof characteristics and desired remaining snow depth (see below) are known, and deep enough that there is no risk of scraping the roof surface or other roof structures, such that there is no need for adjustment.

In other embodiments, which are anticipated to be more common, the bucket or similar device may be made articulated in the arms 35 to make dumping easier. In the case of articulation, known hydraulic, electrical, or mechanical components may be included to cause the bucket to rotate relative to the arms 35. Similarly, any known form of motor and linkage may be included to raise and lower the arms 35 relative to the main body. Moreover, the motor used for propulsion could also drive the arms, depending on the choice of motor.

A bucket as shown has several advantages. For example, it is simple, requiring neither a separate drive motor nor several moving parts; deep or heavy snow will not cause it to jam; and it is easy to empty simply by dumping. Nonetheless, other snow-removal devices may be used instead, including a plow blade, a blower, and even the conventional tiller/auger arrangements, in which case a suitable ejection mechanism should be included. Depending on the construction of the roof on which the robot is used, in particular, if there is no “lip”, it may not be necessary to lift snow at all, put rather it could be pushed over the edge; in these cases, even a simple plow blade would suffice, especially if the clearing pattern starts from the area of the edge over which the snow is to be pushed, working away from this area, so that snow will not pile up in front of the plow blade as the robot moves.

At least one distance/depth sensor system 40 is preferably provided. In FIG. 1, this is shown as being mounted on the front of the main body 10, between the arms 35. This is an advantageous position since it allows for an unimpeded downward view of the snow and the surface to be cleared, but this is only one possible choice of positioning, and the sensor system as such may include a range of sensors located at different positions on the vehicle 100, which communicate with the sensor unit using any known wired or wireless technology. Moreover, if different sensors are included in the system 40, they could be mounted in different positions, depending on the characteristics of a specific implementation of the robot, for example to provide for more unobstructed sensor operation.

The sensor unit 40 preferably includes at least one sensor 41 to measure the local distance to the underlying roof surface and thus, indirectly, determine the local depth of snow. In FIG. 1, the depth sensor is shown as being located on the bucket. This has the advantage of being able to determine the vertical distance to the underlying roof surface closest to the structure so as to enable immediate adjustment of the bucket height to avoid damaging the roof surface or any structures on the surface. At least one other depth sensor is optionally but preferably included to measure the vertical distance to the roof at at least one other position, on the main body of the vehicle. One such additional sensor could be within the unit 40 itself. This will allow the processing system 400 to determine if the vehicle is being caused to pitch up or down relative to the underlying roof surface, since then the distance measurements will change relative to what they are on a flat surface. (Any offset due to a difference in vertical placement of sensors may be pre-calibrated out.) This may be caused by an uneven snow layer, but it may also be caused by unevenness of the roof surface itself; for example, the roof may have ridges, drainage channels, cables or conduits running on it, etc., and the vehicle must avoid damaging these. Downward pitch could, for example, cause the forward edge of the bucket (or other removal device) to contact the roof surface, possibly damaging it or causing the vehicle itself to “jam”. An additional depth sensor on the main body would also allow the processing system to confirm that a snow layer of intended thickness has been left by the bucket.

Snow depth sensors that are external to the robot may also be used, with their depth signals being transmitted to and input by the robot either directly and wirelessly for integration into its internal processing, or indirectly, via a user device 500. such external sensors could include those installed at fixed points on the roof, or on devices such as drones that survey the roof's snow depth before a clearing session, etc. These externally provided depth signals may then be used instead of or combined with the depth measured locally by the robot itself. In these cases “the” depth sensor 41 may comprise a system of different sensing technologies, the sensor mounted on the robot itself and/or external to the robot.

Any known technology, such as laser altimetry (LiDAR) or ultrasound may be used to implement the depth sensor(s) 41. Measurement of snow depth is in a sense “indirect”, in that the sensor 41 primarily measures the distance from the sensor head to the surface underlying the snow, which, in this context, is a building roof.

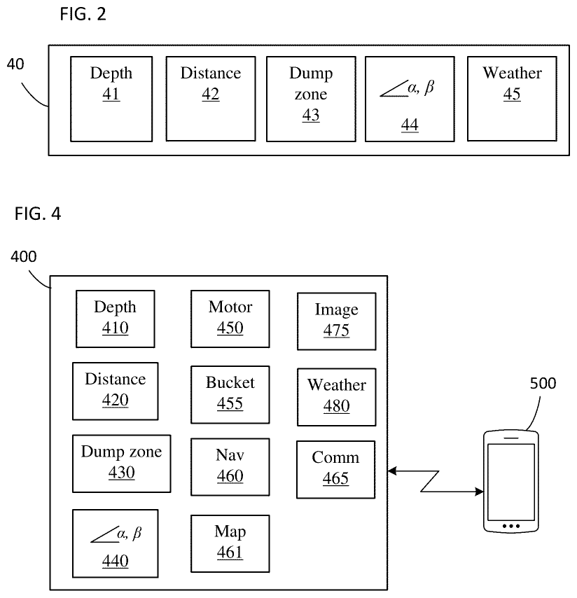

When the robot enters a “valley” or has to move over a “ridge” or simply across the edge between an area that has had snow removed and one that has not, the robot and thus removal device may tend to “roll” about its longitudinal axis (in the direction of travel, with one side lower than the other), or pitch about a lateral axis, with either the front or rear lower than the other, or both. In one embodiment. Compensating for at least pitch using distance sensors is described above. In another embodiment, one or more clinometers 44 are mounted either on the main body, or on the removal device, or both, to measure the leaning angle about one or both of these axes. These may of course be implemented along with or instead of the pitch-detecting feature of the multiple depth sensors. Note than by mounting the clinometer on the removal device, especially if this is a bucket or bucket-like device, then it will also be possible for the system to compensate for pitch changes and continuously adjust its height to maintain a desired set removal depth. In FIG. 2, the clinometer is shown as component 44 and indicates two angles α and β to represent the degree of tilt relative to the horizontal plane about the two axes.

At least one sensor 42 is preferably also included that measures the horizontal distance to objects on the roof. The distance sensor 42, which may be implemented separate or combined with another unit, such as a positioning sensor 50, may, similarly, be implemented using known technology, including the type of radar devices now commonly built into automobiles for such purposes as collision mitigation and parking assistance. Ultrasound is one alternative. The information provided by the sensor 42 is used to detect and avoid obstacles (fixed or movable) by either changing the course of the robot, or halting it.

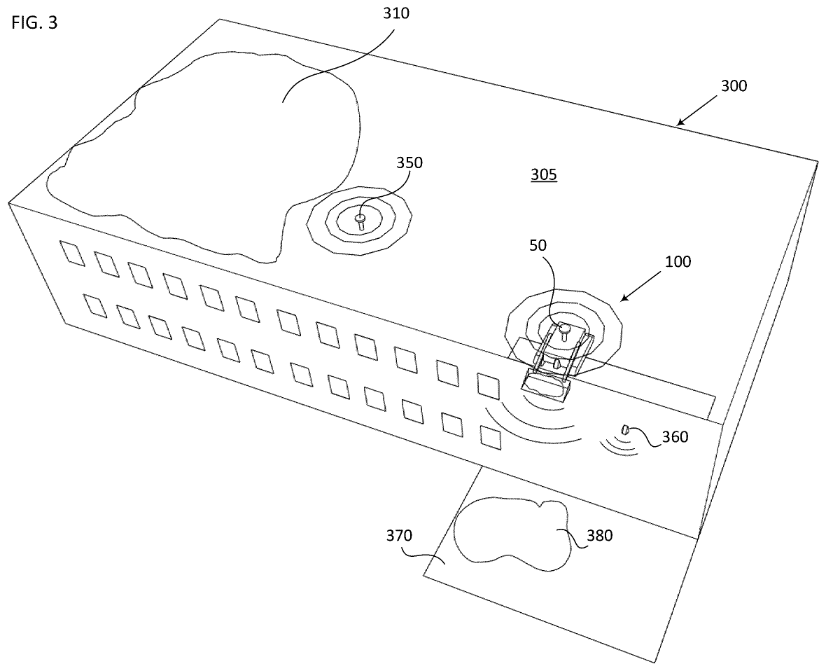

At least one distance sensor 41 may also be configured to detect objects below the outside edge of the roof, although these may be different sensors (such as the dump zone sensor 43 shown in FIG. 1 as being mounted on the bucket 30) given that they may use different sensing techniques. The purpose of the dump zone 43 is to detect objects, people, animals, etc., in the area where the robot may dump the snow it has removed from the roof; the robot may then be repositioned to a clear and safe area, or may be halted until the area is clear. As such, it may include an optical, infrared, or other motion sensor, such as is found in many security cameras and automatic lighting devices, but may also be integrated into a larger system that incorporates external cameras or other forms of motion sensors. This embodiment will be discussed further below, with reference to FIG. 3.

The robot is preferably also provided with a system 50 to determine its position on the roof. This may then be compared with an internally stored map 461 (FIG. 4) of the roof, using any chosen coordinate system. One way to construct such a map is by manual measurements, or by inputting coordinates based on a pre-existing blueprint or image of the roof structure, including features such as HVAC fixtures, antennae, etc. Another method is to set the robot into a mapping mode and allow it to traverse and scan the roof when it is fee of snow. Existing methods are known for carrying out such mapping based on positioning and distance-measuring sensors.

In some embodiments, the robot's positioning system may be based on satellite signals, such as GPS. In other embodiments, the robot's position may be determined using trilateration or triangulation from transmitters having known positions. In still other embodiments, the positioning system may be optical, such that a camera is mounted with a clear line of sight at least in the direction of the robot's travel, whereby known image analysis or even machine learning techniques may be used in the processing unit to detect obstacles in the robot's path, areas that need to be cleared of snow, the edge of the roof, etc. Such embodiments may include an image-processing module 475 within the processing and control system 400. Again, more than one of the disclosed obstacle-avoidance sensors and techniques may be incorporated into the robot.

Positional accuracy may not be as essential in some embodiments. For example, the robot may be able to estimate its position on the roof using the known motion of the respective tracks 20, which can be converted into distance. Any or all of these methods may also be complemented with optical information, or the information from the distance sensor 42. For example, the robot could be programmed to travel in parallel paths, turning when the distance sensor detects that the robot is closer than a predetermined threshold distance to the edge of the roof (which will typically have some form of barrier or raised portion), and then turn through a predetermined angle, such as on a parallel line. It would also be possible simply to let the robot do without a positioning system altogether and simply follow a random path, turning when it reaches an obstacle. Even such essentially random motion could be complimented with information about depth to the roof surface: If the robot, after a turn, senses only a shallow depth, it may assume that that area has already been cleared and then choose a different path.

The path the robot takes may also depend on variables such as current snow load or actual or predicted weather conditions. Some of these options are described below. As for current snow load, the robot may be programmed to clear snow in a pattern that maintains as “balanced” a remaining snow load as possible over the roof. Assume for example that a lot of snow is lying on a roof. If the robot were to clear snow only on one side of the roof, for example, on one side of a ridge, this could cause a large load imbalance, which may endanger the structural integrity of the building. The robot may therefore be programmed to follow a clearing path that minimizes such an imbalance.

As a simple example, the robot could be programmed to clear the area of the roof with the deepest snow cover first, or to clear in multiple “passes”—first clearing to, for example, a maximum of an average depth to ensure balance, and then clearing to the final insulation depth (see below). As another example, the robot could be controlled to follow a path that “spirals” inwards—clearing a path closest to the edge first, then proceeding to the adjacent “concentric” path, and so on to the center. As an alternative, the robot could work from a centerline outwards, or any pattern that leaves a substantially uniform snow distribution over the area of the roof as the robot works, or that at worst maintains no more than a maximum load (corresponding to depth) imbalance snow depth as it clears, where load imbalance can be determined according to any chosen metric. One example of a simple metric may be the difference between the maximum and minimum snow depth on the roof. Other more sophisticated metrics might be clearing so as to reduce as quickly as possible the variance or standard deviation from the preferred insulation depth as the robot clears. Given initial depth measurements at a plurality of points on the roof, this may be computed using known formulas. An advantage of such a load-balancing clearing path is that it would also avoid causing an unacceptably large load imbalance—for example, clearing very deep, heavy snow on one portion of the roof might mean that very deep snow on a different portion of the roof now causes a big, or even bigger, load imbalance.

The robot is preferably configured to self-recharge. To this end, a charging station may be positioned on the roof, with its position either programmed into the robot's internal map, or making itself locatable using a homing signal. As needed, the robot 100 may then navigate itself to the charging station to recharge its internal battery pack. This technique is, however, known even in lawn-mowing robots.

Existing snow-removal machines clear snow as close to the ground as possible; this makes sense given that they are, in fact, operating on the ground, on a driveway or road, or other surface where people or vehicles walk or move. In such scenarios, contact with the underlying surface to be cleared is not a concern. Even in snow-removal devices, such as snow blowers, which use an auger that is vertically offset from the ground, “shoes” or “guides” are typically mounted on the lower edges at the opening of the canopy that forms the chute that channels snow into the auger. These shoes and guides then contact the ground to maintain the vertical auger distance. This clearing method may, however, be disadvantageous when it comes to a roof, especially the usually flat roof of large commercial and residential buildings. First, roofs are typically covered with a protective sheet or material. Scraping the bucket, plow blade, etc., or any other type of supporting members such as the known shoes/guides, on this surface may damage this protective layer and lead to leaking. Second, clearing to the surface may damage other structures and protrusions as well.

In one embodiment, the height of the snow-removing device 30 is set or adjusted to deliberately leave a layer of snow—“residual snow” or a “residual snow layer”—on the roof in accordance with, that is, as a function of, a current depth signal received from the depth sensor(s) 41. The function may be a constant that is either pre-set or input from a user or other external system, or it may be determined by the processing unit 400 itself according to other factors such as measured or estimated snow density, anticipated snowfall or temperature (see below), etc. In other words, snow is deliberately not cleared as close to the underlying surface as possible. This reduces or eliminates the risk of damage to the roof surface, but it also has another benefit: Snow, especially dry but even moist, provides often excellent thermal insulation. By leaving a layer of snow at an insulation depth of between 2 cm and 15 cm deep, and preferably between 5 cm and 10 cm, the roof will be left with such an insulating layer of snow, which may save on energy costs in cold and snowy climates while still avoiding excess snow load on the roof.

Note that all snow removal devices may leave some layer of snow or ice on the underlying surface as an unintended consequence of not wanting to scrape and damage the surface, or not wanting to damage the device itself if the tiller, augur or some other clearing mechanism contacts the surface. These known machines are nonetheless designed to clear as close to the surface as possible and do not—and are not designed to—leave a layer of snow sufficient to provide any insulating effect.

By feeding local depth information, as well as (optionally) information about pitch and/or roll, to the processing system 400, embodiments of the robot provide actively controlled, contact-free snow removal, where “contact-free” refers to all structures other than the tracks, belts, wheels, etc., 20 that allow for movement. Since these devices, such as a belt, may be made of materials such as rubber, these will not damage the roof surface even if there is direct contact with it. Another advantage of active control of the position of the snow-removal device, such as the bucket, is that embodiments are able to easily accommodate different snow depths at different places on the roof. For example, some places on the roof may have more snow accumulation than others.

FIG. 3 illustrates one use scenario for the robot 100, which is shown as being in operation on the roof 305 of a building 300. In the illustration, area 310 on the roof is still covered with snow to be cleared, and the robot is programmed to push or dump snow 380 over the edge of the roof onto an area 370—a snow dump zone—below, or into or onto a receptacle such as a waiting vehicle, for example, a dump or flat-bed truck, or into a container located in the dump zone. Note that, in these cases, the receptacle, of whatever type, will, or will substantially, comprise the snow dump zone itself in that as little snow as possible should land outside it.

One advantage of positioning a container in the dump zone is that it can be left in place until removed according to a schedule, or when the robot determines that the container is full enough to require removal. There are various options for enabling the robot to determine this. One option is optical, using a camera mounted on the robot. Another option would be for the vehicle or container itself to transmit an electromagnetic, optical, or other signal when it is ready to be replaced or emptied, with this signal being sensed via the communications module 465 (see below). Still another option would be for the robot to assume that the receptacle (vehicle, container, etc.) is ready to be replaced or emptied based on the number of loads of snow the robot has dumped. The robot may then transmit a signal to any external system (such as a snow removal service) to communicate the need to empty or replace the receptacle and, unless there is another snow dump zone (of which there may be any number), the robot should stop dumping snow off the roof.

In some cases, the robot simply pushes snow ahead of it like a plow. In others, it uses the bucket 30 to scoop up snow and carry it to where it is to be dumped. The robot is preferably configured to determine when the bucket is in fact full enough, or enough snow has accumulated in front of the plow, to need to be dumped—dumping only a partially filled bucket will tend to lead to the robot making more “trips” to dump than necessary. One way to determine that the bucket is sufficiently full is through any chosen optical, ultrasound, or other sensor system. Where the robot is configured with a bucket the robot could also estimate the volume of snow in the bucket by measuring its weight; since this will be a function of snow density, however, such a weight-based method for measuring snow volume in the bucket may be augmented with a snow density sensor.

In some environments, the robot may freely dump collected snow off of the roof. In many commercial and residential areas, however, doing so may endanger people, pets, or property below. As mentioned above, the robot may be equipped with a dump zone sensor 43 that “looks”, that is, is oriented, downward over the edge of the roof. If the robot detects motion, in particular, movement of people, animals, vehicles, etc., within the area 370, the processing and control system 400, which may receive the signal from the dump zone sensor, and, using a dump zone module 430, may control the robot so that the signal dumping procedure is paused until the area is clear. Known techniques may be used if necessary to discriminate between moving objects so that, for example, swaying trees do not cause a halt to the snow removal process. As an alternative, the robot may be programmed to move along the edge of the roof to locate a dumping area that is clear of people, animals, etc., or to move to a pre-programmed alternative dumping position and check if it is safe to dump there.

In some embodiments, the dump zone sensor 43 may be enough to enable the robot to evaluate the dumping area 370. In the embodiment illustrated in FIG. 3, however, the robot 100 receives signals derived from one or more existing cameras 360, such as security cameras, installed in the building 300, which thus forms the dump zone “sensor” 43 instead of, or together with, the one shown in FIG. 1 as being located on the robot itself. The robot may receive “raw” video data that it itself processes (for example, using the image-processing module 475) to determine the presence of objects (people, etc.) in the dumping area(s), or an external unit such as a robot controller or controller application may interpret the image(s). Once externally processed, the external unit itself could cause a “halt” command to be transmitted to the robot; alternatively, the results of image interpretation could be transmitted back to the robot, which itself decides which course of action to follow.

In some cases, the robot 100 may be programmed “oppositely” with respect to dumping: The system may be configured to detect the presence of an empty dump truck or other removal vehicle or container in the snow dump zone 370 and to dump snow only when such a receptacle is present. Rather than automatic detection, it would also be possible to provide the driver/user of a removal vehicle with the ability, for example via a remote control, smart phone app, or other signaling device, to send a signal to the robot to cause it to dump its current load of snow, after which the robot may continue removing its next load of snow. Communication could also be made two-way, such that the robot signals to the user that it is ready to dump.

A transmitter 350 may be positioned on the roof, either to communicate wirelessly (illustrated by the sets of concentric circles) using any known technique with the robot to transmit positional signals, or user commands, or both. This need not be a transmitter only, but rather, in some implementations, the device 350 may also be configured to receive transmissions from the robot as well, such as status information about itself or the snow state, video signals, including of a dump zone (see below), etc.

FIG. 4 illustrates some of the main software components that may be included in the processing and control system 400 in the robot 100. Standard hardware and software components such as a processor, some form of operating system, and volatile and non-volatile storage are included but not shown. The processor is provided to execute the code that defines the modules shown in FIG. 4 to carry out their respective functions; the code itself is embodied in the volatile and non-volatile storage.

Software modules 410, 420, 430, and 440 are included to receive the signals generated by the respective sensors 41, 42, 43, and 44 and process them to generate the corresponding processable data. A motor control component 450 is included to generate the signals controlling the speed and direction of the traction arrangement (tracks, wheels, etc.).

In embodiments in which is it not fixed, a component 455 is included to control the operation of the removal device, such as the bucket 30. In some embodiments, this may involve only one degree of freedom, namely, the rotational position of the arms 35; in other embodiments, control may also involve a second degree of freedom, namely, the rotational position of the bucket relative to the arms. The processing system 400 may therefore input a desired residual snow depth (either pre-stored, received from a user device, or based on weather-related calculations), input current depth data from the one or more sensors 41, and adjust the position of the snow-removal device 30 to achieve the intended residual snow layer thickness, which may be any value from 0 upwards. Note that a value of 0 would correspond to total clearing down to the roof surface, which a user might choose for a roof in which this is desirable and safe, and where no residual insulating layer of snow is to be left.

A navigation component 460 is preferably included not only to determine the robot's position on the roof, but also to store and, in some embodiments, generate or download, a digitally represented map of the roof on which the robot is working. The computations necessary to determine position will depend on the location method chosen in any given implementation of the robot, but will be familiar to those who work with geolocation systems.

A communications component 465 may also be included to receive and transmit signals, both from onboard sensors and, if implemented, external devices and systems such as a user device 500, to a control center, etc. Any suitable associated antenna may therefore be included within or mounted on the robot. The user device may be a computer or server, or a portable device such as a smart phone or tablet. Via the user device, a user may then not only receive information about the status of the robot, such as any fault signals, the battery state, data indicating current snow depth and temperature, etc., but may also enter commands and data to control the operation of the robot, such as map data relating to the current roof. Note, however, that the robot may be implemented to operate totally autonomously, requiring little or no monitoring or input after initial configuration for a given roof.

In another embodiment, the robot is configured to autonomously adapt its operational schedule, snow-removal route on the roof, removal characteristics (such as residual snow depth), etc., or any combination or all of these, as a function of current or predicted weather. Either directly, via internal weather sensors 45, or via communication with the external unit 500, the processing system 400 could also either measure selected weather data and/or input this, as well as predictive weather information and process this in a corresponding module 480. This information may then be used for scheduling, as well as residual depth needs, and possibly even routing. The internal weather sensors 45 may be the same as or similar to those found in many home or professional weather stations that have a predictive capability by sensing such parameters as changes in barometric pressure, temperature, relative humidity, wind direction, etc., and apply known algorithms to predict the likelihood of precipitation.

Assume the processing system receives data (either from the external unit 500, from internal measurements, from directly accessing a weather signal from a meteorological service, etc.) that heavy snowfall is predicted to occur in the next 24 hours, with a strong northerly wind. The processing system, using both the map in the navigation module 460 and the weather module 480, which interprets this information, may then set a removal schedule that begins sooner and/or is more frequent, than whatever it is currently set to. It could also take into account geometry-dependent such as that the windward side of the roof, especially windward of structures such as storage sheds, large HVAC assemblies, angled sections, etc., are likely to experience heavier snow accumulation than areas of the roof that are open or lie in the lee. The processing unit may then establish a clearing route on the roof that prioritizes those windward areas. It may then also schedule more frequent clearing than if the prediction is for several precipitation-free days. This may then reduce the likelihood of snow load imbalance.

As another example, assume the robot's weather module 480 determines or receives data indicating that an impending snowstorm will occur at temperatures near or even above 0° C. It may then conclude that this snow is likely to be more dense than snow that occurs during a period of much lower temperatures. The processing system may then choose to reduce the depth of residual snow, that is, of the snow layer the robot leaves, so as to avoid excess weight. It would also be possible to make this adjustment in real time, meaning by actual, current measurement of the conditions on the roof the robot is operating on.

The optimal thickness of the residual snow layer, either in general, or per-roof or per-roof type or per-roof geometry, etc., may be determined using known methods, for example, by testing, taking into account such factors as different snow densities, roof structures, etc., or may simply be set per-roof. These values may then be stored in the depth module 410 and, when communicated to the bucket module 455, used to control bucket positioning to achieve the intended residual snow depth.

1. A robot for clearing snow, comprising:
a main body;
a traction arrangement enabling motion of the robot on snow lying on a roof of a building;
a snow-removal device connected to the main body;
at least one depth sensor;
a processing and control unit that:
controls at least one motor to drive the traction arrangement such that the robot follows a snow-clearing path;
receives a depth signal from the at least one depth sensor; and
as a function of the depth signal, actively controls a snow-clearing depth by actuating the snow-removal device and, as the robot follows the snow-clearing path, adjusting a vertical snow-clearing distance so as to deliberately leave a layer of snow of a pre-determined insulation depth on the roof after clearing and to prevent contact by the snow-removal device with a surface of the roof, such that, during snow removal, no part of the snow-removal device comes into contact with the roof surface other than at most the traction arrangement.

2. The robot according to claim 1, in which the processing and control unit controls the traction arrangement so that the robot autonomously follows a snow-clearing path.

3. The robot according to claim 2, in which the processing and control unit includes an internal map of the roof.

4. The robot according to claim 1, in which:
the robot is configured to dump snow from the roof over an edge of the roof onto a snow dump zone that is located outside a periphery of and below an edge of the roof;
the processing and control unit includes a dump zone module that receives and processes at least one dump zone signal from at least one dump zone sensor; and
the dump zone signal corresponds to the presence or absence of objects within the snow dump zone; and
the processing and control unit selectively initiates and prevents the dumping of snow from the roof according to the dump zone signal.

5. The robot according to claim 4, in which at least one dump zone sensor is mounted on the robot.

6. The robot according to claim 4, in which the dump zone module receives and processes at least one dump zone signal from at least one dump zone sensor is a the dump zone signal from at least one sensing arrangement external to the robot.

7. The robot according to claim 6, in which the sensing arrangement external to the robot is a camera arrangement mounted on the building.

8. The robot according to claim 1, further comprising a weather module within the processing and control unit, in which:
the weather module receives meteorological data corresponding to the region of the building; and
the processing and control unit selectively schedules snow removal and determines at least one of the snow-removal path and the vertical snow-clearing distance according to the meteorological data.

9. The robot according to claim 1, in which the processing and control unit determines the snow-removal path so as to maintain at most a maximum load imbalance snow depth on the roof during the snow clearing.

10. The robot according to any preceding claim 1, in which the robot operates autonomously.

11. A method for clearing snow from a roof, comprising:
controlling motions of a snow-removal robot on the roof, said robot having a main body, a traction arrangement enabling motion of the robot on snow lying on a roof of a building, a snow-removal device connected to the main body, and at least one depth sensor;
controlling the traction arrangement such that the robot follows a snow-clearing path;
receiving a depth signal from the at least one depth sensor; and
as a function of the depth signal, actively, as the robot follows the snow-clearing path, controlling a snow-clearing depth by actuating the snow-removal device and adjusting a vertical snow-clearing distance so as to leave a layer of snow of a pre-determined depth on the roof after clearing and to prevent contact by the snow-removal device with a surface of the roof, such that, during snow removal, no part of the snow-removal device comes into contact with the roof surface other than at most the traction arrangement;
in which the robot carries out the snow-removal autonomously, independent of user control of the robot's motions.

12. The method according to claim 11, further comprising creating and storing a map of the roof within the robot.

13. The method according to claim 11, further comprising:
within the robot itself, receiving at least one dump zone signal from at least one dump zone sensor, the dump zone signal corresponding to the presence or absence of objects within a snow dump zone that is located outside a periphery of and below an edge of the roof; and
selectively initiating and preventing the dumping of snow by the robot from the roof according to the dump zone signal.

14. The method according to claim 13, in which the at least one dump zone sensor is mounted on the robot.

15. The method according to claim 13, further comprising receiving the at least one dump zone signal from at least one sensing arrangement external to the robot.

16. The method according to claim 15, in which the sensing arrangement external to the robot is a camera arrangement mounted on the building.

17. The method according to claim 13, further comprising determining whether a snow receptacle in the snow dump zone is able to receive more dumped snow and refraining from further dumping of snow if it is not.

18. The method of claim 17, further comprising transmitting a signal to an external system selectively indicating a need to empty and replace the receptacle when it is determined not to be able to receive more dumped snow.

19. The method according to claim 11, further comprising:
receiving meteorological data corresponding to the region of the building; and
autonomously, by processing within the robot, selectively scheduling snow removal and determining at least one of the snow-removal path and the vertical snow-clearing distance according to the meteorological data.

20. The method according to claim 11, further comprising determining, and establishing within the robot, the snow-removal path so as to maintain at most a maximum load imbalance snow depth on the roof during the snow clearing.
